(19) United States
(12) Patent Application Publication
(10) Pub. No.: US 2005/0041577 A1
(43) Pub. Date: Feb. 24, 2005

(54) Rate limiting through dynamic autocorrection

(76) Inventors: Emil Tiller, Adelaide (AU); Choe Kent Lam, Adelaide (AU)

Correspondence Address: AKERMAN SENTERFITT, P.O. BOX 3188, WEST PALM BEACH, FL, 33402-3188, US

(21) Appl. No.: 10/497,216

(22) PCT Filed: Dec. 2, 2002
(86) PCT No.: PCT/AU02/01630

(30) Foreign Application Priority Data
Nov. 30, 2001 (AU) PR 9181

(51) Int. Cl. H04L 12/28; H04L 12/56

(52) U.S. Cl. 370/229; 370/235; 370/395.21

(57) ABSTRACT

A packet switching arrangement to effect rate control of acceptance of presented packets for transmission through an outgoing channel, including calculation of an autocorrection factor which permits accurate rate control, limiting burstiness while also limiting under-utilisation.

### TECHNICAL FIELD

This invention relates to improved bit rate limiting in a packet switching arrangement.

### BACKGROUND ART

Token Bucket Filtering (TBF) to limit channel bit rate is known.

TBF has a concept of a conceptual bucket which fills up at a set rate with tokens until it reaches an upper limit of the bucket. For a channel to be able to send a packet it must obtain enough tokens to be able to send the packet. Once the packet has been sent, these tokens are discarded. If the channel cannot obtain all of the required tokens, it must wait for the bucket to fill up with more tokens before sending.

There are two main problems with this for certain rate limiting scenarios. Firstly, because the bucket can hold a number of tokens, TBF filtering allows traffic to burst above the rate at which the bucket is being filled up for a period of time before it stabilises to the rate at which tokens are being replenished.

Another problem is that it can be inaccurate since round off errors in the tokens are not taken into consideration. In TBF, to calculate how many tokens go into the bucket, a time difference between current time and the time in which the tokens were last calculated is made and multiplied by the rate at which the bucket is refilled. This can lead to a situation where a fraction of a token should be given to the bucket but it is not because tokens are integer values. If a fraction of a token is missed out every time, the cumulative affect over time can be a large round-off error—especially if the rate of token refill is low.

It is an object of the present invention to provide a rate limiting mechanism that minimises initial channel bursts and limits a channel to a given rate without any round off errors or at the least provide the public with a useful alternative.

### DISCLOSURE OF THE INVENTION

In one form of the invention this can be said to reside in a packet switching arrangement to effect rate control of acceptance of presented packets for transmission through an outgoing channel, including means storing a value representing a selected number of bits, means to allow a presented packet to be transmitted only where such packet will transmit within the said selected number of bits, measuring any remaining available number of bits that could be transmitted within the selected available number of bits subsequent to the said transmission and where there is some remaining bits to be transmitted but which is not a sufficient number of bits for transmission in full of a next presented packet, and means to increase the stored value representing the selected number of bits by such a remaining number of bits or substantially that number of bits for the immediately following selected length of time.

In another form of the invention this can be said to reside in a packet switching arrangement to effect rate control of acceptance of presented packets for transmission through an outgoing channel, including means for storing a value representing a selected number of bits to be transmitted in a selected length of time, means to allow a presented packet to be transmitted only where the number of bits in such packet combined with the number of bits already transmitted in the selected length of time is within said selected number of bits, means to measure a remaining number of bits that could be transmitted within the selected available number of bits subsequent to the said transmission but which is not a sufficient number of bits for transmission in full of a next presented packet, and means to increase the stored value representing the selected number of bits by such a remaining number of bits or substantially that number of bits for the immediately following selected length of time.

In preference there are further included means for detecting that an inactive period has occurred when no packets have been transmitted for one or more selected lengths of time when packets were available to be sent, means for increasing the stored value representing the selected number of bits allowed to be transmitted over a selected length of time by an amount substantially equal to the remaining number of bits plus the number of bits which could have been transmitted in the inactive period, less the number of bits in all the packets presented for transmission during the inactive period.

In preference the selected length of time is time required to transmit a largest allowable packet.

In preference the selected length of time is the smallest time unit distinguishable by a physical implementation.

In another form of this invention it can be said to reside in a method of effecting packet switching to effect rate control of acceptance of presented packets for transmission through an outgoing channel, including storing a value representing a selected number of bits for transmission over a selected period, allowing a presented packet to be transmitted only where such packet would be transmitted with the said selected number of bits or less, measuring any remaining available number of bits within the selected length of time subsequent to the said transmission and where there is some remaining bits which are not sufficient to transmit in full a next presented packet, then increasing the stored value representing the selected number of bits allowable by such a remaining number of bits or substantially that number of bits for the immediately following selected length of time.

In yet another-form of this invention it can be said to reside method of effecting packet switching to effect rate control of acceptance of presented packets for transmission through an outgoing channel, including storing a value representing a selected number of bits allowed to be transmitted over a selected length of time, allowing a presented packet to be transmitted only where the number of bits in such packet combined with the number of bits already transmitted in the selected period is within said selected number of bits, measuring a remaining number of bits that could be transmitted within the selected length of time subsequent to the said transmission which are not sufficient to transmit in full a next presented packet, then increasing the stored value representing the selected number of bits allowable by such remaining number of bits or substantially that number of bits for the immediately following selected length of time.

In preference there are further included the steps of establishing that an inactive period has occurred when no packets have been transmitted for one or more selected lengths of time when packets were available to be sent, then increasing the stored value representing the selected number of bits allowed to be transmitted over a selected length of time by an amount substantially equal to the remaining number of bits plus the number of bits which could have been transmitted in the inactive period, less the number of bits in all the packets presented for transmission during the inactive period.

Other forms of the invention will be appreciated by reference to the remaining description and may comprise a part or all of the following features.

For a better understanding of the invention it will now be described with relation to a preferred embodiment where, however, it will be understood the specific embodiment illustrates only one form of the invention.

### BRIEF DESCRIPTION OF THE DRAWINGS

FIG. 1 provides a graphical representation of the method; and

FIG. 2 shows a functional block diagram representation of the same embodiment.

### BEST MODE FOR CARRYING OUT THE INVENTION

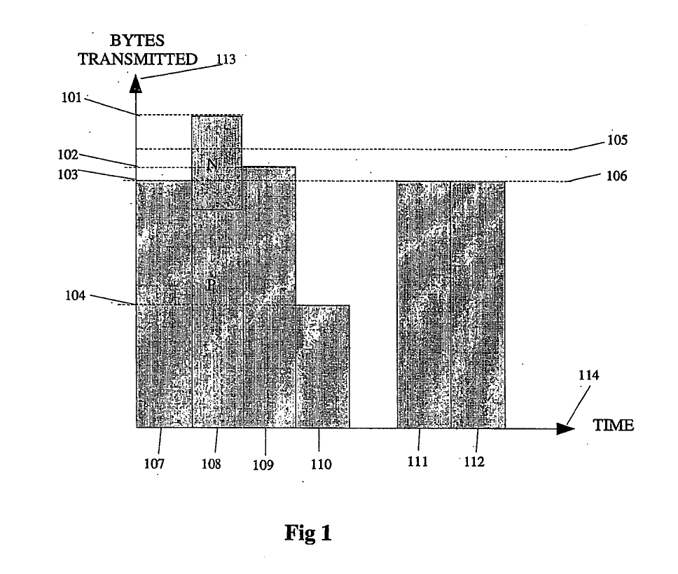

Referring in detail to the drawings there is shown a Y axis 113 which represents a number of bytes transmitted. The X axis 114 represents time. Time is quantised in the system. The size of the quanta is selected as the greater of the length of time it would take to transmit the largest packet allowed in the system, or the kernel time resolution of the system. FIG. 1 shows contiguous time quanta 107, 108, 109 and 110. It further shows contiguous time quanta 111 and 1 12 separated at a time interval greater than one time quanta.

The line 106 represents the selected bit rate of the outgoing link. This is also the minimum value of the limit to the number of bits the system will be allowed to send in any time quantum. For the first time quantum the number of bytes permitted to be transmitted 103 will be the same as the minimum level, in the second time quantum the upper limit on the number of packets that can be sent is still unchanged. During this second time quantum a packet N of size N bits is queued for transmission while the number of bits already sent in this second time quantum is P. The sum 101 of N and P is clearly greater than the limit level 103, so the packet will not be transmitted. Since the actual number of bytes sent, P, is less than the limit 103, this results in an auto correction value being calculated, which is the difference between the limit level 106 and the value P. This value is added to the minimum level 106 to give the transmission limit 105 for the immediately following time quantum. In the third time quantum the channel has a number of bits 102 to send. Since this is below the limit 105 this transmission is allowed to proceed.

The kernel continually asks for a packet to be sent from the system. It is not until the kernel has requested a packet that a packet may be sent. The kernel may under some circumstances not ask for a packet within a time quantum or series of time quanta due to other loads. This represents a failing on the outgoing link that must be accounted for during the next time quantum.

Consider the system at some arbitrary time quantum 112. If at this time quantum the kernel asks for a packet and finds that packets were ready to be sent but the kernel has not been able to forward a packet since a previous time greater than one time quantum previously, then a new auto correction coefficient needs to be calculated for the time quantum which is in effect equal to the auto correction factor at the last kernel request minus the sum of all packets accumulated during the kernel's busy period plus the number of packets that could have been sent during the busy period.

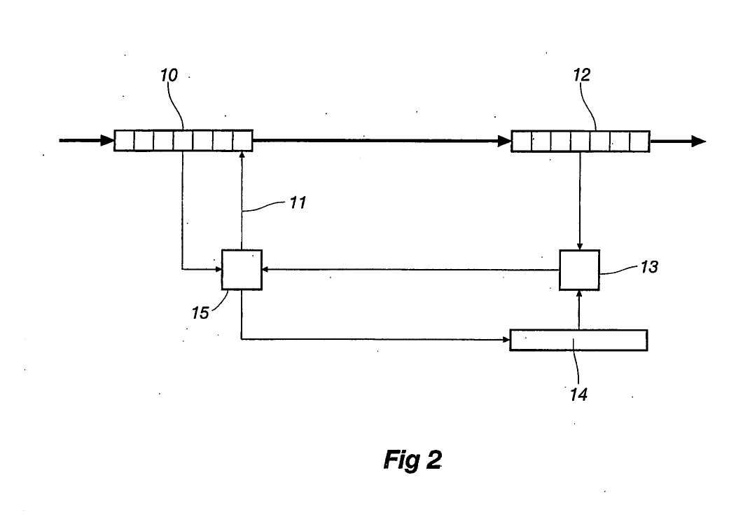

Considering FIG. 2 there is an incoming data buffer 10 which also acts as a counter to determine the size of each incoming packet. There is an outgoing buffer 12 which also acts as a counter for determining the number of bits transmitted. There is a storage element 14 which stores the value of the maximum number of bits which are to be transmitted in the current time quanta. This value is initially set to the level 106 which is the selected overall bit rate to be maintained on the outgoing link.

Data packets are received by input buffer 10 but are not transmitted to output buffer 12 until an acceptance signal 11 is provided by autocorrection routine 15.

This routine compares the packet size with the number of bits of capacity available for transmission in the current time period, providing an acceptance signal only if the packet size is less than or equal to this remaining capacity. This remaining capacity value is calculated by comparison routine 13 by comparing the number of bits transmitted, supplied by the outgoing counter 12 with the value for the number of bits allowed to be sent during this time period stored in the storage element 14.

If the autocorrection routine 15 determines that the packet is not to be sent, no acceptance signal is provided, and no further packets are sent in this time period. If the remaining capacity value is not zero, this value is the autocorrection value. This autocorrection value is added to the initial value for the maximum number of bits to be transmitted in a time quanta (106) and the resulting value stored in the storage element 14.

The process then repeats for the next time quantum.

The autocorrection routine 15 is able to detect the occurrence of a period when no packets have been transmitted for one or more selected lengths of time when packets were available to be sent. It then calculates the autocorrection value as the sum of the remaining capacity value from the last time period when bits were successfully sent plus the number of bits which could have been transmitted in the inactive period, less the number of bits in all the packets presented for transmission during the inactive period. This autocorrection value is then added to the initial value for the maximum number of bits to be transmitted in a time quanta (106) and the resulting value stored in the storage element 14.

1. A packet switching arrangement to effect rate control of acceptance of presented packets for transmission through an outgoing channel, including means storing a value representing a selected number of bits, means to allow a presented packet to be transmitted only where such packet will transmit within the said selected number of bits, measuring any remaining available number of bits that could be transmitted within the selected available number of bits subsequent to the said transmission and where there is some remaining bits to be transmitted but which is not a sufficient number of bits for transmission in full of a next presented packet, and means to increase the stored value representing the selected number of bits by such a remaining number of bits or substantially that number of bits for the immediately following selected length of time.

2. A packet switching arrangement to effect rate control of acceptance of presented packets for transmission through an outgoing channel, including means for storing a value representing a selected number of bits to be transmitted in a selected length of time, means to allow a presented packet to be transmitted only where the number of bits in such packet combined with the number of bits already transmitted in the selected length of time is within said selected number of bits, means to measure a remaining number of bits that could be transmitted within the selected available number of bits subsequent to the said transmission but which is not a sufficient number of bits for transmission in full of a next presented packet, and means to increase the stored value representing the selected number of bits by such a remaining number of bits or substantially that number of bits for the immediately following selected length of time.

3. An arrangement as in claim 2 including means for detecting that an inactive period has occurred when no packets have been transmitted for one or more selected lengths of time when packets were available to be sent, means for increasing the stored value representing the selected number of bits allowed to be transmitted over a selected length of time by an amount substantially equal to the remaining number of bits plus the number of bits which could have been transmitted in the inactive period, less the number of bits in all the packets presented for transmission during the inactive period.

4. An arrangement as in claim 2 where the selected length of time is time required to transmit a largest allowable packet.

5. An arrangement as in claim 2 where the selected length of time is the smallest time unit distinguishable by a physical implementation.

6. A method of effecting packet switching to effect rate control of acceptance of presented packets for transmission through an outgoing channel, including storing a value representing a selected number of bits for transmission over a selected period, allowing a presented packet to be transmitted only where such packet would be transmitted with the said selected number of bits or less, measuring any remaining available number of bits within the selected length of time subsequent to the said transmission and where there is some remaining bits which are not sufficient to transmit in full a next presented packet, then increasing the stored value representing the selected number of bits allowable by such a remaining number of bits or substantially that number of bits for the immediately following selected length of time.

7. A method of effecting packet switching to effect rate control of acceptance of presented packets for transmission through an outgoing channel, including storing a value representing a selected number of bits allowed to be transmitted over a selected length of time, allowing a presented packet to be transmitted only where the number of bits in such packet combined with the number of bits already transmitted in the selected period is within said selected number of bits, measuring a remaining number of bits that could be transmitted within the selected length of time subsequent to the said transmission which are not sufficient to transmit in full a next presented packet, then increasing the stored value representing the selected number of bits allowable by such remaining number of bits or substantially that number of bits for the immediately following selected length of time.

8. A method as in claim 7 further including the steps of establishing that an inactive period has occurred when no packets have been transmitted for one or more selected lengths of time when packets were available to be sent, then increasing the stored value representing the selected number of bits allowed to be transmitted over a selected length of time by an amount substantially equal to the remaining number of bits plus the number of bits which could have been transmitted in the inactive period, less the number of bits in all the packets presented for transmission during the inactive period.

9. A digital computer programmed to effect the method of claim 7.
